(19) United States
(12) Patent Application Publication
(10) Pub. No.: US 2022/0374785 A1
(43) Pub. Date: Nov. 24, 2022

(54) Machine Learning System

(71) Applicant: Hitachi High-Tech Corporation, Tokyo (JP)

(72) Inventors: Masayoshi ISHIKAWA, Tokyo (JP); Sota KOMATSU, Tokyo (JP); Yuichi ABE, Tokyo (JP); Mitsuji IKEDA, Tokyo (JP)

(21) Appl. No.: 17/734,667

(22) Filed: May 2, 2022

(30) Foreign Application Priority Data
May 21, 2021 (JP) 2021-086000

(51) Int. Cl. G06N 20/20; G06K 9/62

(52) U.S. Cl. CPC G06N 20/20; G06K 9/6257

(57) ABSTRACT

A machine learning system performs transfer learning to output a trained model by performing training using a parameter of a pre-trained model by using a given dataset and a given pre-trained model. The machine learning system includes a dataset storage unit that stores one or more datasets, and a first training unit that performs training using a dataset stored in the dataset storage unit to generate the pre-trained model, and stores the generated pre-trained model in a pre-trained model database. The dataset storage unit stores tag information including any one or more of domain information indicating a target object of data included in a dataset to be stored, class information indicating a class included in data, and data acquisition condition information related to an acquisition condition of data and a dataset in a manner that the tag information and the dataset are associated with each other.

### CLAIM OF PRIORITY

The present application claims priority from Japanese Patent application serial no. 2021-86000, filed on May 21, 2021, the content of which is hereby incorporated by reference into this application.

### BACKGROUND OF THE INVENTION

### 1. Field of the Invention

The present invention relates to a machine learning system that performs data processing by machine learning, and particularly to a machine learning system effective for building a machine learning model with high speed and high accuracy for a new dataset.

### 2. Description of the Related Art

In a machine learning technique for performing data processing, particularly, a multilayer neural network called deep training, a method called transfer learning for improving performance with a new dataset by using pre-trained model or training data in the past is frequently used.

For example, JP 2016-143094 A describes that, in order to efficiently perform transfer learning, by evaluating a relationship between a value of an output layer of a trained neural network and a class of a new dataset in the new dataset, an output unit having a higher frequency at which an evaluation value having a smallest difference from a class of an evaluation item is acquired is preferentially assigned.

### SUMMARY OF THE INVENTION

JP 2016-143094 A provides a system suitable for transfer learning by appropriately assigning a class of a new dataset to an output unit of a pre-trained neural network. However, since the transfer learning strongly depends on the nature of a dataset used for training in advance, there is a case where it is difficult to obtain a benefit of the transfer learning.

First, in a case where the number of classes of a dataset to be newly trained is larger than the number of classes trained in advance, the method provided in JP 2016-143094 A cannot be used.

Second, it is difficult to correctly obtain performance for a class that has not been trained in advance. For example, in a case where only a class related to a tool such as a hammer or a nail is trained, it is difficult to sufficiently extract information necessary for recognizing a class related to an animal such as a dog or a cat.

Third, even in a case where class granularity of a new dataset is more subdivided than a pre-trained model, it is difficult to extract information necessary for recognizing a new class. For example, in a case where classification of an animal such as a dog or a cat is recognized in pre-training and then classification of a dog is subdivided in a new dataset, there is a high possibility that similar features are extracted in many of new datasets in a trained model since original datasets are classified into a single class of a dog, and thus, and it is difficult to obtain a benefit by transfer learning.

Fourth, in a task different from that of a dataset used for pre-training, it is necessary to initialize most of a machine learning model to perform training. For example, in a case where object detection is performed with a new dataset after image classification is performed by pre-training, it is necessary to add a large number of neural network layers in addition to a pre-trained model at the time of transfer learning, and training may be prolonged.

As described above, in a case where transfer learning is performed, performance of a new dataset greatly changes depending on a dataset used for pre-training and a training task. For this reason, an object of the present invention is to provide a machine learning system that easily performs an appropriate pre-trained model and improves performance at the time of transfer learning.

A machine learning system that performs transfer learning to output a trained model by performing training using a parameter of a pre-trained model by using a given dataset and a given pre-trained model. The machine learning system includes a dataset storage unit that stores one or more datasets, and a training unit that performs training using data stored in the dataset storage unit to generate a pre-trained model database. A pre-trained model is obtained by data of the pre-trained model database, the dataset storage unit stores tag information including one or more of domain information indicating a target object of data included in a dataset to be stored, class information indicating a class included in data, and data acquisition condition information related to an acquisition condition of data and a dataset in a manner that the tag information and the dataset are associated with each other.

According to the present invention, in a machine learning system that acquires a machine learning model by transfer learning, it is possible to facilitate configuration of an appropriate pre-trained model and to realize high accuracy and high speed in training with a new data set.

An object, a configuration, and an advantageous effect other than those described above will be clarified in description of an embodiment described below.

### BRIEF DESCRIPTION OF THE DRAWINGS

FIG. 1 is a diagram illustrating a configuration example of a multilayer neural network;

FIG. 2 is a diagram illustrating a configuration example of transfer learning;

FIG. 3 is a diagram illustrating a configuration example of a machine learning system according to a first embodiment of the present invention;

FIG. 4 is a flowchart illustrating a behavior of the machine learning system according to the first embodiment of the present invention;

FIG. 5 is a diagram illustrating a configuration of a dataset storage unit;

FIG. 6 is a diagram illustrating a configuration of a pre-trained model database;

FIG. 7 is a diagram illustrating a configuration of a dataset relevance evaluation unit;

FIG. 8 is a flowchart illustrating operation of a dataset relevance evaluation unit;

FIG. 9 is a block diagram illustrating a configuration of the machine learning system according to the first embodiment of the present invention including a user interface;

FIG. 10 is a diagram illustrating a user interface relating to a dataset integration unit;

FIG. 11 is a diagram illustrating a user interface relating to a training unit; and

FIG. 12 is a flowchart illustrating operation of the training unit in a second embodiment.

### DESCRIPTION OF THE PREFERRED EMBODIMENTS

Hereinafter, an embodiment of the present invention will be described with reference to the drawings. Note that detailed description of an overlapping portion will be omitted.

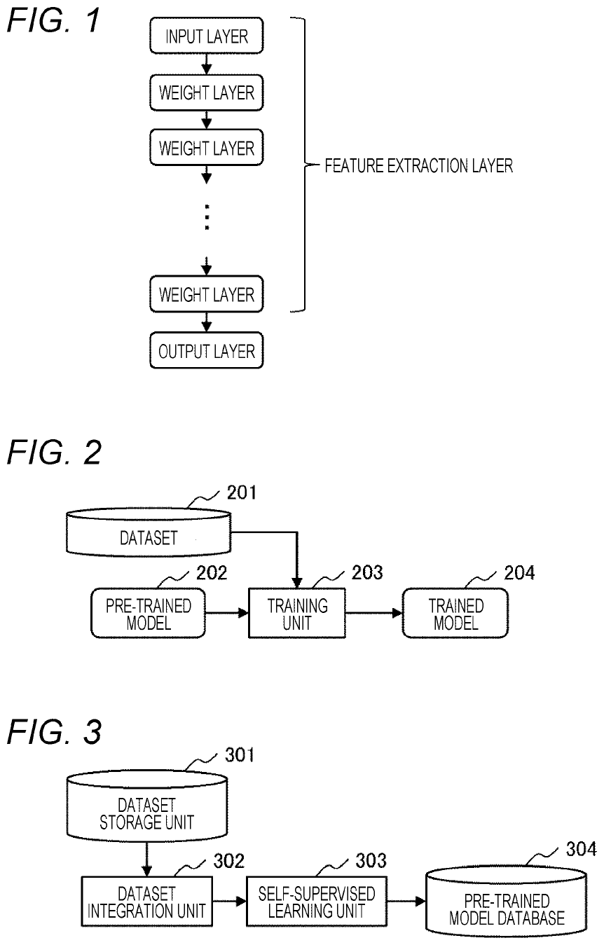

Before description of an embodiment of the present invention, a configuration of a transfer learning function as a premise of application of the present invention will be described with reference to FIGS. 1 and 2.

First, FIG. 1 illustrates a configuration example of a multilayer neural network called deep training. As illustrated in FIG. 1, a model of deep training includes a plurality of layers. This is an input layer to which data is input, a weight layer that performs feature extraction from input data and output of another weight layer, and an output layer that performs output that is a processing result by using an extracted feature. In the present invention, one or more layers in front of the output layer are referred to as feature extraction layers.

FIG. 2 illustrates a configuration example of transfer learning. In the transfer learning, by using a given dataset 201 and a given pre-trained model 202, a training unit 203 performs training using a parameter of the pre-trained model, and outputs a trained model 204.

In order to increase an effect of the transfer learning in the transfer learning having such a configuration, it is necessary to train the pre-trained model 202 with a dataset having a larger number of classes than the dataset 201 to be trained, or including a class similar to a class included in the dataset 201, or having a subdivided class granularity.

However, a configuration of such a dataset for the pre-trained model 202 requires a large number of man-hours and is generally difficult. Further, even in a case where a plurality of datasets are combined, in a case where tasks are different for each dataset, the datasets cannot be simply combined. For example, in image classification and object detection, it is difficult to simply integrate datasets because annotation formats are different.

Further, even if tasks are the same, an effect of transfer learning cannot be obtained only by simple combination. For example, in a case of training an image classification model that classifies dog species, even if image classification by sample observation with a microscope is performed in advance, the effect of transfer learning is less.

The present invention has been made in view of such a situation, and provides a machine learning system for efficiently managing a plurality of datasets and easily performing appropriate pre-training with an appropriate dataset.

### First Embodiment

Hereinafter, a machine learning system that can easily secure a dataset for the pre-trained model 202 in the configuration of transfer learning illustrated in FIGS. 1 and 2 will be described.

FIG. 3 illustrates a configuration example of a machine learning system according to a first embodiment of the present invention. The machine learning system in FIG. 3 includes a dataset storage unit 301, a dataset integration unit 302, a self-supervised learning unit 303, and a pre-trained model database 304. Data accumulated in the pre-trained model database 304 is used for pre-training as a dataset for the pre-trained model in FIG. 2.

In FIG. 3, the dataset storage unit 301 stores a plurality of datasets in association with tag information based on a domain, a data class, a data acquisition condition, and the like of each dataset.

Here, the domain indicates an object of data such as an animal, a natural object, or an artificial object. This is, for example, in a case of article inspection, inspection target information such as an industrial product, a medical image, or a semiconductor image, or information regarding a lower-order inspection process such as cell inspection or an etching process.

The data class is class information included in dataset. This is, for example, information regarding a class included in the domain such as a dog or a cat, and, in a case of an inspection process, it is a type of a cell or a bacterium to be inspected or a defect type.

A data acquisition condition is information related to an acquisition condition of data included in a dataset. This is, for example, information regarding a data acquisition device such as an optical camera, an optical microscope, an electron microscope, a radar, an infrared ray, an X-ray, and a sound, or information regarding an acquisition condition such as magnification, exposure time, resolution, an integration number, and a sampling frequency.

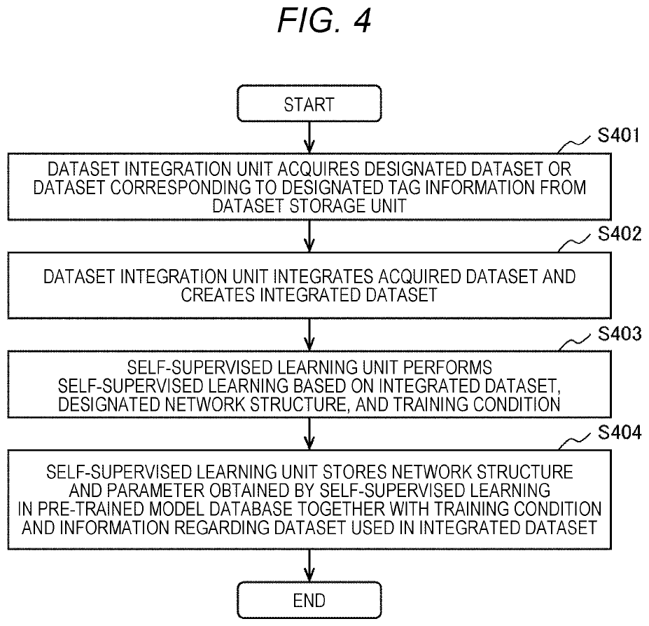

FIG. 4 is a flowchart illustrating a behavior of the machine learning system according to the first embodiment of the present invention illustrated in FIG. 3. In a series of processing of FIG. 4, first, in a processing step S401 corresponding to processing of the dataset integration unit 302, a dataset corresponding to a designated dataset or designated tag information is acquired from the dataset storage unit 301. Subsequently, in a processing step S402 corresponding to processing of the dataset integration unit 302, datasets acquired from the dataset storage unit 301 are integrated to create an integrated dataset.

Here, the integration of datasets is to extract only input data from a plurality of datasets acquired in the processing step S401 to obtain a larger dataset. In this manner, for example, in a case where two datasets A and B are acquired in the processing step S401, the number of data included in an integrated dataset after the integration is the sum of the number of data included in the dataset A and the number of data included in the dataset B. At this time, in a case where there is data included in both the dataset A and the dataset B, the number of data included in the integrated dataset may be the number of unique data by avoiding duplicated data.

At this time, by using a method not using labels included in the dataset acquired in the processing step S401 in the self-supervised learning unit 303, it is possible to easily create an integrated dataset obtained by integrating a plurality of datasets acquired in the processing step S401 even in a case where a format and class granularity of label included in a plurality of datasets acquired in the processing step S401 are different.

Note that, here, the format of label may be different for each task of each dataset in such a manner that, for example, the label includes class information such as a class name and a class number for an image in a case of image classification, the label includes information in which position information showing an object is associated with class information for an image in the case of object detection, and the label includes class information or instance information associated with each pixel in the case of segmentation.

Further, in a case of an image translation task such as noise removal, a three-dimensional reconfiguration task such as depth estimation from an image, or the like, one in which class information is not given is also included. Further, even in a case where there is no label depending on a dataset, the present invention can be used because the label is not used.

Further, an integration method of datasets may be changed by use of label of a plurality of acquired datasets. For example, in a case of classification of anomaly data, data imbalance in which the number of data is different for each class in one dataset frequently occurs for a reason such as that there are anomalies that are likely to occur and anomalies that rarely occur. In such a case, an integrated dataset may be configured such that each class is used with the same probability as much as possible at the time of pre-training. That is, the sampling probability of each data in an integrated dataset may be changed, or the number of data of each class may be adjusted so as to be approximately the same and then integrated as an integrated dataset.

Next, in a processing step S403 corresponding to processing of the self-supervised learning unit 303, self-supervised learning is performed using the integrated dataset created in the processing step S402. Here, a network structure and a training condition of a neural network as a target of the self-supervised learning are set in advance.

Here, the self-supervised learning is, for example, training by SimCLR (Non-Patent Document; Tien Chen, Simon Kornblith, Mohammad Norouzi, GeoffreyHinton, A Simple Framework for Contrastive training of Visual Representations, International Conference on machine learning, 2020).

SimCLR is a method in which, after two different random transformations are applied to data included in a training dataset, training is performed such that the two random transformed images have the same feature and images obtained from different images have different feature.

SimCLR can be interpreted as a training method to discriminate all instances included in a training dataset. That is, it can be interpreted that a dataset having most subdivided class granularity is trained without depending on class granularity of a dataset to be used. For this reason, in pre-training by SimCLR, a task that is more difficult than assumed needs to be solved, and a detailed feature extraction layer can be trained. In a case of training with a dataset similar to a new dataset, an appropriate pre-trained model can be acquired.

However, even if a plurality of datasets are simply integrated and self-supervised learning such as SimCLR is performed, it is difficult to configure an appropriate pre-trained model. In general, a neural network is trained by a stochastic gradient descent method or a its variants. In the stochastic gradient descent method, partial data is acquired as a mini-batch from the entire dataset, and an update amount of a parameter of a neural network is computed by using the mini-batch.

In contrast, in self-supervised learning such as SimCLR, training is performed so that each data included in the acquired mini-batch can be identified. If datasets are integrated while tag information such as a domain of the datasets is ignored, the mini-batch includes datasets of various domains. For this reason, it is possible to sufficiently identify each data by identification of a domain in self-supervised learning, and the effect of integrating datasets is weakened.

This means that, for example, in a case where a dataset based on an image obtained by imaging a general object such as a dog or a cat with an optical camera and a dataset of sample observation with a microscope are integrated, and a mini-batch includes a general object image and a microscope image, since image characteristics of both images are greatly different, both can be identified with simple information. In such a case, if only domain information can be identified, a value of a loss function at the time of training becomes small. For this reason, the dataset acquired in the processing step S401 is desirably data of a similar domain.

Conversely, performing self-supervised learning with only a single dataset so as not to integrate datasets of a plurality of domains also reduces an effect of pre-training by self-supervised learning. For example, even in a case where the number of data included in a dataset on which pre-training is performed is small, it is possible to identify each data only with a relatively simple feature.

From the above viewpoint, a dataset used for pre-training performed by the self-supervised learning unit 303 is desirably constituted by limited tag information and desirably includes as much data as possible. Note that, although the configuration based on SimCLR is described, another self-supervised learning method may be used.

In a processing step S404 corresponding to processing of the self-supervised learning unit 303, a parameter of a pre-trained model obtained by the self-supervised learning in processing step S403 is stored in the pre-trained model database 304 together with a network structure, a training condition, and information regarding a dataset used in the integrated dataset created in processing step S402.

With such a configuration, the present invention can provide a machine learning system for efficiently managing a plurality of datasets and easily performing appropriate pre-training with an appropriate dataset. That is, the system stores each dataset in association with tag information in the dataset storage unit 301, acquires and integrates datasets with one or more pieces of designated tag information to configure an integrated dataset, and performs pre-training of a neural network capable of performing detailed feature extraction by self-supervised learning assumed to be more difficult than a new task.

At this time, a dataset suitable for self-supervised learning can be configured by managing the dataset in association with the tag information. That is, by configuring a dataset as large as possible with limited domain information, data classes, and data acquisition conditions by using tag information, a more detailed feature extraction layer can be trained by self-supervised learning.

According to such a configuration, in a case of use for a plurality of inspection processes existing during a manufacturing process, it is possible to efficiently perform transfer learning in a new inspection process by integrating datasets of a plurality of inspection processes and performing pre-training.

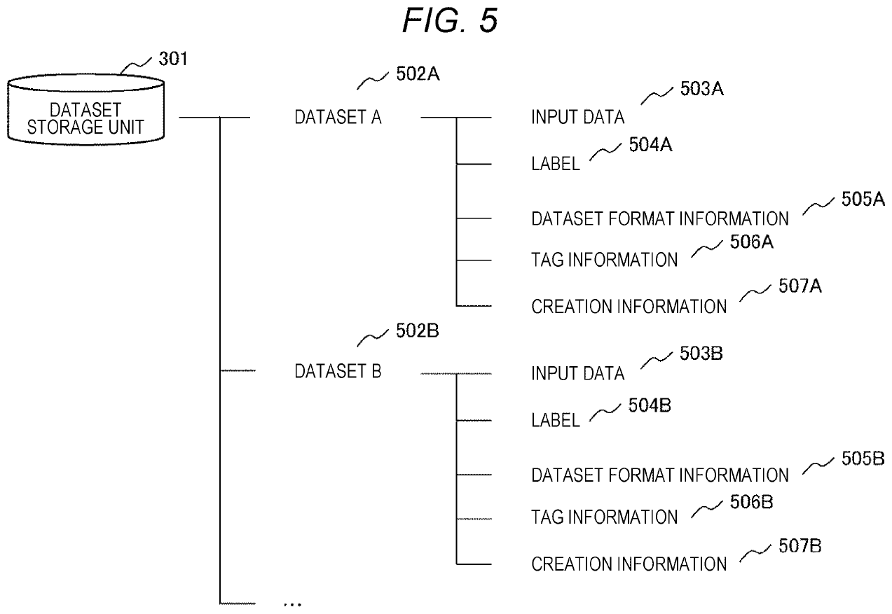

FIG. 5 illustrates a data configuration example of the dataset storage unit 301 used in the present invention. The dataset storage unit 301 stores a plurality of datasets 502 (502A and 502B in the illustrated example). dataset identification information is allocated to each of the datasets 502A and 502B. This is allocated to each dataset like 502A and 502B in FIG. 5. This is information including a name of a dataset, a unique character string or numeric string, a name of a dataset, a unique character string, creation date and time, registration date and time, version information, and the like.

Each of the datasets 502A and 502B includes input data 503, label 504, dataset format information 505, tag information 506, and creation information 507, which are stored in association with each other. Further, these are stored for each dataset. That is, as illustrated in FIG. 5, input data 503A and 503B, label 504A and 504B, dataset format information 505A and 505B, tag information 506A and 506B, and creation information 507A and 507B are created for a dataset A and a dataset B, respectively.

First, the input data 503 is input data included in each of the datasets 502. For example, an image obtained by capturing an image of an observation target or an image after processing corresponds to this.

The label 504 is label corresponding to input data included in each of the datasets 502. This is configured such that a correspondence with each input data can be known by a specific rule. Further, in a case of a dataset in which there is no label, the label 504 may not be provided.

The dataset format information 505 stores information regarding a format of the dataset 502. This is information about a task of a dataset or about a storage format of a dataset depending on a task, such as, for example, whether the dataset is in a format of image classification or in a format of object detection. The information may be configured so that correspondence between the input data 503 and the label 504 can be known by the dataset format information 505. Further, in a case where class information or the like of each piece of data is referred to when an integrated dataset is integrated in Step S402, the dataset format information 505 may be used.

The tag information 506 is tag information based on a domain, a data class, a data acquisition condition, and the like of each of the datasets 502. Domain information indicates an object of data included in a dataset, class information indicates a class included in data, and data acquisition condition information relates to an acquisition condition of data.

The creation information 507 is information given when the dataset 502 is created. For example, the creation information 507 is information related to the date and time when the dataset is created or version information of the dataset. Here, the version information of the dataset 502 may include information identifying specific processing performed on the dataset. This is, for example, that specific preprocessing has been applied, or that label has been checked by a plurality of people.

In a case where a plurality of the same datasets having different creation dates and times and version information are included in the dataset storage unit 301 by using the creation information 507, the dataset storage unit 301 outputs data to the dataset integration unit 302 on the basis of a rule set in advance. Here, the rule set in advance is to output a latest dataset, to output one in which a specific character string is included in version information, or the like.

As described above, various types of information are stored in the dataset storage unit 301, but here, in the present invention, a dataset and the tag information 506 are stored in the dataset storage unit 301 in association with each other. In this case, it can be said that a dataset includes the input data 503 and the label 504, and the tag information 506 includes one or more pieces of domain information indicating an object of data included in the input data 503, class information indicating a class included in data, and data acquisition condition information regarding an acquisition condition of data. Furthermore, there is a difference in that the dataset is information obtained from an observation target, and the tag information is human information formed by the user appropriately performing manual input according to a situation of an observation target.

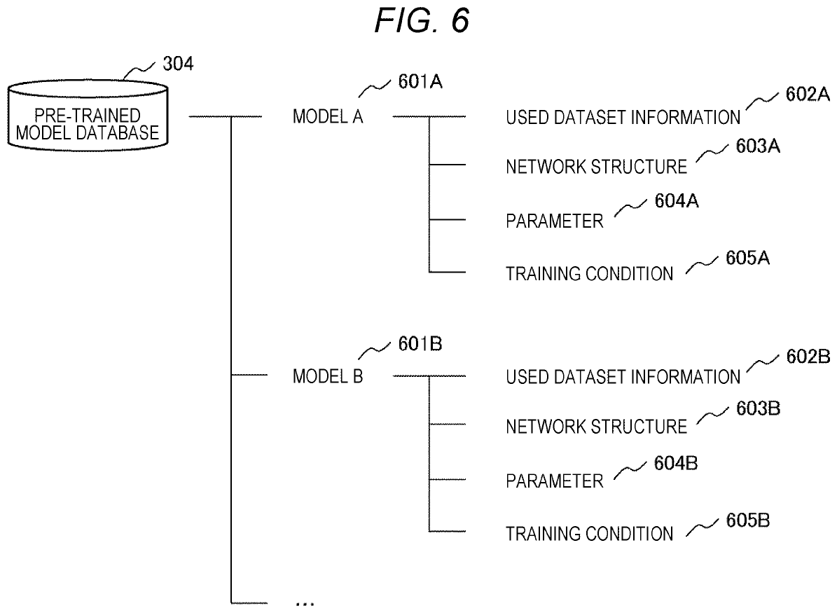

FIG. 6 is a diagram illustrating a data configuration example in the pre-trained model database 304 of FIG. 3. The pre-trained model database 304 includes model information 601, used dataset information 602, a network structure 603, a parameter 604, and a training condition 605.

Among them, the model information 601 (601A, 601B) is information allocated to each model. This is a name of a model, a unique character string or numerical string, or information including a name of a model, a unique character string, creation date and time, registration date and time, version information, and the like. As illustrated in FIG. 6, the data is individually allocated to a plurality of models such as a model A 601A and a model B 601B.

Further, the used dataset information 602, the network structure 603, the parameter 604, and the training condition 605 are managed for each piece of the model information 601. That is, used dataset information 602A and 602B, network structures 603A and 603B, parameters 604A and 604B, and training conditions 605A and 605B are respectively assigned to a model A (601A) and a model B (601B) and stored.

The used dataset information 602 stores information regarding a dataset integrated by the dataset integration unit 302 and an integration condition when each of the pre-trained models 202 is trained. This is, for example, dataset identification information regarding the integrated dataset, or the tag information 506 that is designated. When performing transfer learning with a new dataset, the user can check tag information trained by each model by referring to the used dataset information 602 associated with each model, and select a pre-trained model appropriate for training of the new dataset.

Information regarding a network structure of each model is stored in the network structure 603. Since the network structure affects recognition accuracy and processing time, the user can select a model having a network structure that satisfies a requirement of a new dataset by checking the network structure 603.

As the parameter 604, a parameter of a pre-trained model trained by the self-supervised learning unit 303 is stored. The user can realize efficient transfer learning by using this parameter.

The training condition 605 stores a training condition used for pre-training in the self-supervised learning unit 303. This is, for example, the number of updates of a parameter, or information regarding a batch size, a learning rate, a learning rate schedule, a method of the stochastic gradient descent variants, and the like.

Further, in order to efficiently select a dataset to be integrated by the dataset integration unit 302, relevance between datasets stored in the dataset storage unit 301 may be evaluated, and datasets having a similar feature may be integrated.

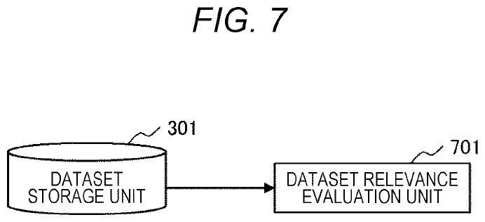

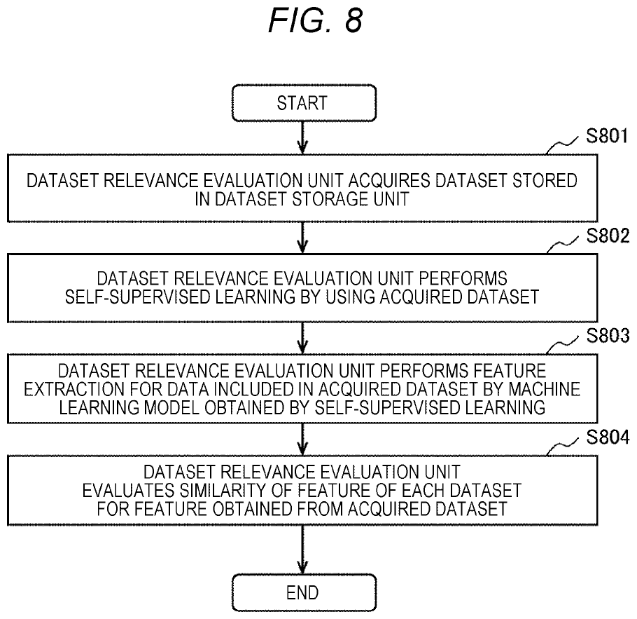

FIG. 7 illustrates a configuration of a dataset relevance evaluation unit 701 that evaluates relevance between datasets, and FIG. 8 illustrates a processing process of the dataset relevance evaluation unit 701.

The dataset relevance evaluation unit 701 in FIG. 7 evaluates how similar data included in each dataset is. In the pre-training by the self-supervised learning unit 303 in FIG. 3, it is important to integrate a large number of similar datasets, and thus it is possible to perform efficient pre-training by evaluating the similarity between the datasets in advance.

In the processing process of evaluating the relevance between datasets in FIG. 8, first, in a processing step S801, the dataset relevance evaluation unit 701 acquires a dataset stored in the dataset storage unit 301. Here, the configuration may be such that only a dataset having specific tag information is acquired using the tag information 506 associated with each dataset, or conversely, a dataset is acquired without limitation by tag information.

In a processing step S802, the dataset relevance evaluation unit 701 performs self-supervised learning by using the dataset acquired in the processing step S801. The self-supervised learning performed here may be the same as or different from the self-supervised learning used by the self-supervised learning unit 303.

In a processing step S803, the dataset relevance evaluation unit 701 performs feature extraction on data included in the dataset acquired in the processing step S802 by using a machine learning model obtained by the self-supervised learning in the processing step S801.

In a processing step S804, the dataset relevance evaluation unit 701 evaluates similarity of feature for each dataset by using the feature obtained in the processing step S803. Here, the evaluation of similarity of feature for each dataset may be a value obtained from a distance obtained by a distance function such as a Euclidean distance or a cosine distance between average values of the feature for each dataset or a value obtained from a value of divergence or entropy such as the Kullback-Leibler divergence between distributions of the feature for each dataset.

As described above, the dataset relevance evaluation unit 701 can evaluate the relevance such as how similar datasets are by evaluating a relationship of a feature for each dataset obtained when a plurality of datasets are integrated and self-supervised learning is performed. The user can appropriately select a dataset to be integrated by the dataset integration unit 302 by using this information.

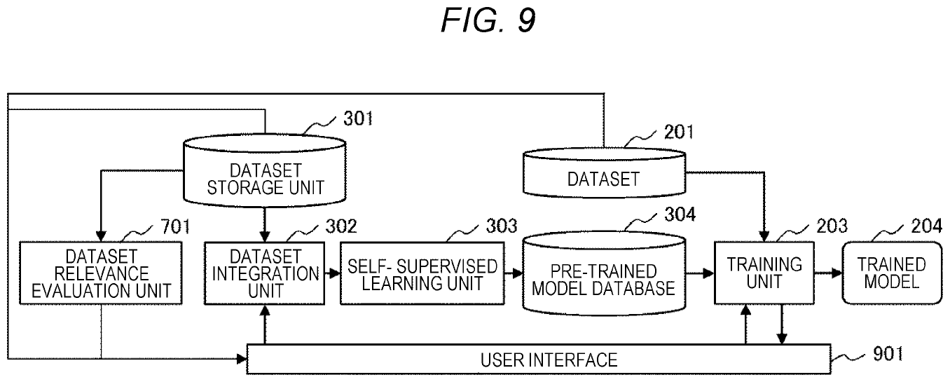

FIG. 9 illustrates a configuration example of the present invention including a user interface 901. In FIG. 9, a constituent portion including the dataset 201, the pre-trained model 202, the training unit 203, and the trained model 204 is the transfer learning mechanism having a general configuration to which the present invention illustrated in FIG. 1 can be applied.

In contrast, a constituent portion including the dataset storage unit 301, the dataset integration unit 302, the self-supervised learning unit 303, and the pre-trained model database 304 is the dataset creation mechanism for the pre-trained model according to the present invention illustrated in FIG. 3. Further, a constituent portion including the dataset storage unit 301 and the dataset relevance evaluation unit 701 is the dataset relevance evaluation mechanism illustrated in FIG. 7.

These mechanisms are organically connected by the user interface 901, and various settings, operation instructions, result confirmation, and the like are performed by the user. Specifically, for example, the user can select a dataset to be integrated by the dataset integration unit 302 or select the pre-trained model 202 used by the training unit 203 by using the user interface 901.

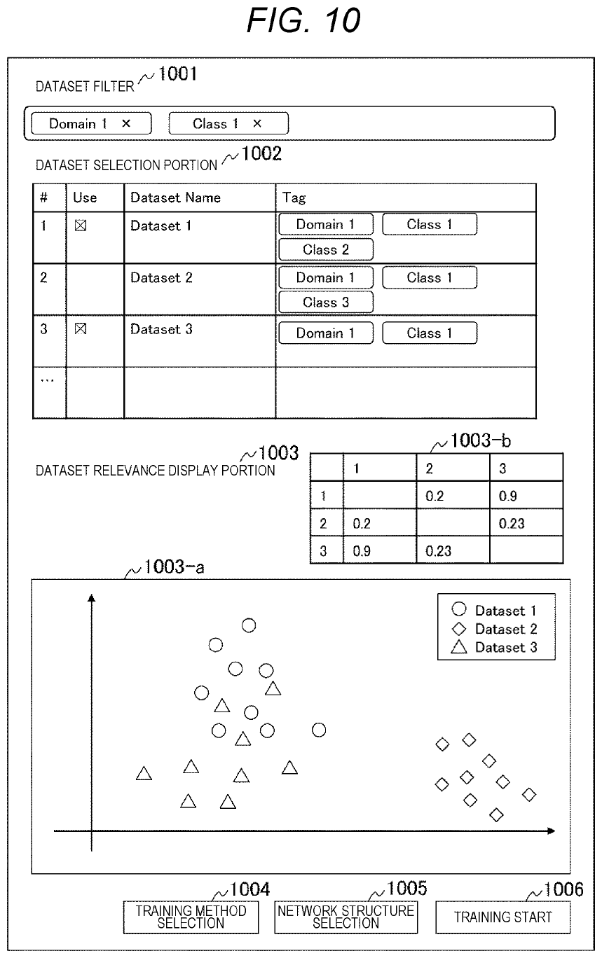

FIG. 10 illustrates a display screen example as a user interface regarding setting of pre-training. As a screen configuration example used in the setting of pre-training, a dataset filter portion 1001, a dataset selection portion 1002, and a dataset relevance display portion 1003 are provided as information display portions, and a training method selection portion 1004, a network structure selection portion 1005, and a training start portion 1006 are provided as operation instruction units for button operation and the like.

With this screen, the user can select a dataset used for pre-training and select a training method and a network structure of self-supervised learning used by the self-supervised learning unit 203.

In the dataset filter portion 1001, the user can operate a dataset displayed on the dataset selection portion 1002 or the dataset relevance display portion 1003 by inputting tag information such as a domain or a data class for which pre-training is to be performed, a data acquisition condition, and the like. This makes it possible to select a dataset to be efficiently used without displaying an irrelevant dataset.

In the dataset selection portion 1002, each dataset is displayed together with the tag information 506 associated with the dataset, and the user can select a dataset to be used for pre-training. Further, brief description of a dataset may be displayed on the dataset selection portion 1002 by being stored in the dataset storage unit 301 in association with the dataset.

In the dataset relevance display portion 1003, a value obtained by two-dimensionally or three-dimensionally mapping a feature of each dataset evaluated by the dataset relevance evaluation unit 701 is displayed. Here, two-dimensional or three-dimensional mapping of a feature of a dataset is realized by, for example, manifold learning or the like.

By changing a mark to be displayed for each dataset, it is easy for the user to check the similarity of feature between datasets. For example, in the example of FIG. 10, features of three datasets are displayed on a dataset relevance display portion 1003-a, and a feature related to Dataset 1 indicated by a circle and a feature related to Dataset 3 indicated by a triangle exist in close regions, but a feature related to Dataset 2 indicated by a rhombus exists in a region away from Dataset 1 and Dataset 3. In such a case, if the user determines to use Dataset 1, it is possible to easily identify that a similar dataset is Dataset 3, and it is possible to easily examine whether or not integration is possible.

Note that a thumbnail of each data may be displayed together with a mark of each feature. Further, the similarity between datasets evaluated by the dataset relevance evaluation unit 701 may be displayed in a tabular form like a dataset relevance display portion 1003-b to present a similar dataset to the user.

In the training method selection portion 1004, the user can select a training method and a training condition of self-supervised learning used in the self-supervised learning unit 203.

In the network structure selection portion 1005, the user can select a network structure of a pre-trained model to be used in the self-supervised learning unit 203.

In the training start portion 1006, in a case where the user supports start of training, pre-training is performed using the dataset selected in the dataset selection portion 1002, the training method and the training condition selected in the training method selection portion 1004, and the network structure selected in the network structure selection portion 1005, and a pre-trained model is stored in the pre-trained model database 304.

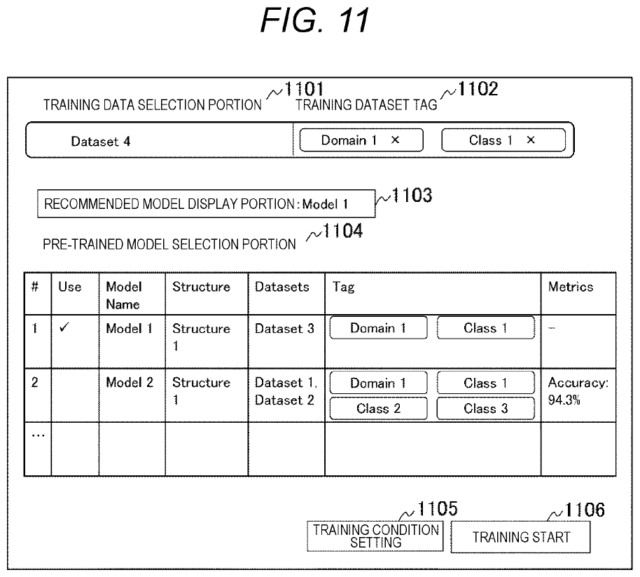

FIG. 11 illustrates a display screen example as a user interface when transfer learning is performed.

As a screen configuration example used in transfer learning, a training data selection portion 1101, a training dataset tag display portion 1102, and a recommended model display portion 1103 are provided as information display portions, and a pre-trained model selection portion 1104, a training condition setting portion 1105, and a training start portion 1106 are provided as operation instruction portion for button operation and the like.

In the training data selection portion 1101, the user selects the dataset 201 to be trained. This may be newly registered, or may be stored in the dataset storage unit 301 in advance.

In the training dataset tag display portion 1102, tag information regarding the dataset 201 to be trained is displayed. This may be input by the user in a case where the target dataset 201 as a training target selected by the training data selection portion 1101 is new, or the tag information 506 stored in the dataset storage unit 301 may be displayed in a case where the dataset is stored in advance in the dataset storage unit 301.

In the recommended model display portion 1103, a model recommended based on an evaluation result of the dataset relevance evaluation unit 701 is displayed. The model may not be displayed in a case where there is no applicable one, may be displayed when there is a plurality of applicable ones, or one to be displayed may be limited under a specific condition such as one that is most recommended, or the models may be displayed in order of degree of recommendation.

Here, the degree of recommendation of each model is similarity between a feature obtained by a model based on self-supervised learning by the dataset relevance evaluation unit 701 with respect to a dataset selected in the training data selection portion 1101 and a feature obtained by the dataset 602 used for training of each pre-trained model. A dataset trained with a dataset having high similarity is also effective in transfer learning.

In the pre-trained model selection portion 1104, the user can select the pre-trained model 202 to be used for transfer learning from the pre-trained model database 304. Here, the model information 601, the used dataset information 602, the network structure 603, and the like stored in the pre-trained model database 202 are displayed. Further, in a case where evaluation by transfer learning has already been performed, an evaluation index such as a accuracy may be displayed together.

In the training condition setting portion 1105, the user can set a training condition at the time of transfer learning.

When the training start portion 1106 is selected by the user, transfer learning is executed using the selected dataset 201, the pre-trained model 202, and a training condition.

### Second Embodiment

According to the present invention described in the first embodiment, if the dataset storage unit 301 includes a dataset that sufficiently covers data included in the new dataset 201, training of the feature extraction layer may be sufficiently completed by pre-training. In such a case, if only the output layer is newly trained, the trained model 204 that is highly accurate can be acquired at high speed.

In the present embodiment, a configuration for further speeding up training at the time of transfer learning in such a case will be described.

A stochastic gradient descent method is used for training of a normal neural network, but the stochastic gradient descent method requires a large number of parameter updates before convergence. For this reason, training can be speeded up by using an optimization method such as a quasi-Newton method, a natural gradient method, or a subspecies of the method that converges with a smaller number of parameter updates.

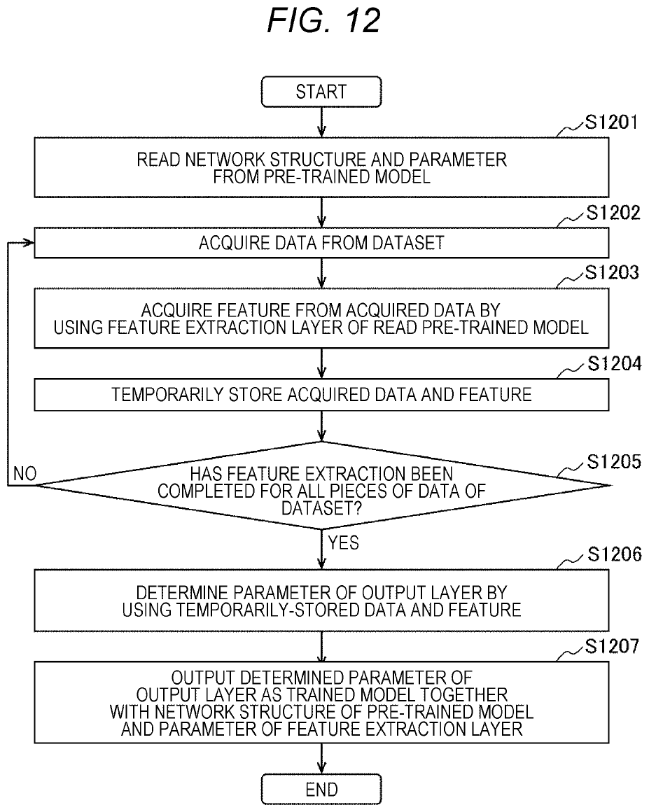

FIG. 12 illustrates a process in a case where only the output layer is trained at a higher speed. In a first processing step S1201 in FIG. 12, the training unit 203 reads the network structure 603 and the parameter 604 from the pre-trained model 202.

In a processing step S1202, the training unit 203 acquires data from the dataset 201.

In a processing step S1203, the training unit 203 extracts a feature from the data acquired from the processing step S1202 using the feature extraction layer of the read pre-trained model 202.

In a processing step S1204, the training unit 203 temporarily stores the acquired data and the feature.

In a processing step S1205, the training unit 203 checks whether or not feature extraction is completed for all the data of the dataset 201. In a case where the feature extraction is not completed, the process returns to the processing step S1202. In a case where the feature extraction is completed, the process proceeds to a processing step S1206.

In a processing step S1206, a parameter of the output layer is determined using the data and the feature temporarily stored in the training unit 203. The output layer is trained by a quasi-Newton method such as an L-BFGS method, a natural gradient method, or the like using label included in data associated with the extracted feature.

In a processing step S1207, the training unit 203 outputs the parameter of the output layer determined in the processing step S1206 together with the network structure 603 of the pre-trained model 202 and the parameter 604 of the feature extraction layer as the trained model 204.

Note that the present invention is not limited to the above embodiment and includes a variety of variations. For example, the above embodiment is described in detail for better understanding of the present invention, and the present invention is not necessarily limited to an embodiment that includes all the described configurations. Further, a part of a configuration of a certain embodiment can be replaced with a configuration of another embodiment, and a configuration of a certain embodiment can also be added to a configuration of another embodiment. Further, for a part of a configuration of each embodiment, other configurations can be added, removed, or replaced with

What is claimed is:

1. A machine learning system that performs transfer learning to output a trained model by performing training using a parameter of a pre-trained model by using a given dataset and a given pre-trained model, the machine learning system comprising:
a dataset storage unit that stores one or more datasets; and
a first training unit that performs training using a dataset stored in the dataset storage unit to generate the pre-trained model, and stores the generated pre-trained model in a pre-trained model database, wherein
the dataset storage unit stores tag information including any one or more of domain information indicating a target object of data included in a dataset to be stored, class information indicating a class included in data, and data acquisition condition information related to an acquisition condition of data and a dataset in a manner that the tag information and the dataset are associated with each other.

2. The machine learning system according to claim 1, further comprising:
a dataset integration unit that integrates a plurality of datasets stored in the dataset storage unit and outputs the datasets as an integrated dataset, wherein
the dataset integration unit acquires a designated dataset or a dataset corresponding to designated tag information from the dataset storage unit, integrates the acquired dataset, and outputs the dataset to the first training unit as an integrated dataset.

3. The machine learning system according to claim 2, wherein
the first training unit performs pre-training by self-supervised learning using the integrated dataset and outputs the pre-trained model to the pre-trained model database, and
the pre-trained model database stores information regarding a dataset used in the integrated dataset used for training by the first training unit or tag information used in the integrated dataset in association with the pre-trained model.

4. The machine learning system according to claim 3, further comprising:
a dataset relevance evaluation unit that evaluates similarity between datasets stored in the dataset storage unit.

5. The machine learning system according to claim 4, further comprising:
a second training unit that performs transfer learning using the pre-trained model stored in the pre-trained model database and a given dataset and outputs a trained model, wherein
the second training unit trains only an output layer of a pre-trained model.

6. The machine learning system according to claim 5, wherein
the second training unit performs training by a quasi-Newton method or a natural gradient method and an extension thereof.
